(19) United States
(12) Patent Application Publication
(10) Pub. No.: US 2005/0169259 A1
(43) Pub. Date: Aug. 4, 2005

(54) Switching hub architecture and index-shared packet transfer method thereof

(75) Inventor: Chien-Hua Su, Hsiu Chu (TW)

Correspondence Address: Mr. Peter F. Corless;EDWARDS & ANGELL, LLP, 101 Federal Street, Boston, MA, 02110, US

(73) Assignee: RDC Semiconductor Co., Ltd, Taiwan, R.O.C.

(21) Appl. No.: 10/768,305

(22) Filed: Jan. 29, 2004

(51) Int. Cl. H04L 12/56

(52) U.S. Cl. 370/389

(57) ABSTRACT

A switching hub architecture and index-shared packet transfer method thereof are proposed, which allow a switching hub to perform a port-to-port packet transfer procedure, a port-to-microprocessor packet transfer procedure, and a microprocessor-to-port packet transfer procedure in an index-shared manner that can help enhance packet transfer efficiency. The proposed switching hub architecture and index-shared packet transfer method thereof is characterized in that the embedded packet-switching control unit and microprocessor are both capable of retrieving an index from the same packet index buffer that is pointed to an unoccupied packet buffer area in the packet buffer memory. This index-shared scheme allows the port-to-port packet transfer procedure, the port-to-microprocessor packet transfer procedure, and the microprocessor-to-port packet transfer procedure to be carried out more efficiently than prior art.

### FIELD OF THE INVENTION

The present invention relates to a computer network data transfer technique, and more particularly, to a switching hub architecture and an index-shared network packet transfer method thereof, which is suitable for a switching hub in a network system and allows the switching hub to perform various packet transfer procedures in an index-shared manner.

### DESCRIPTION OF THE PRIOR ART

Switching hub, being one of the key elements within the network system, consists of several ports, and these ports are connected to a plurality of network nodes so that packets can be transferred between the network nodes.

There are three types of data transfer tasks for a switching hub: (1) port-to-port packet transfer procedure used to transfer packets received by one port to the other port; (2) port-to-microprocessor packet transfer procedure used to transfer packets received by a port to an internal microprocessor for processing; and (3) microprocessor-to-port packet transfer procedure used to transfer the packets processed by a microprocessor to a port, and through the port to network node(s).

The above three types of packet transfer procedures all require a memory to store the packets, and then the packet is taken out of the memory and transferred to a microprocessor or a destined port.

However, one problem of the packet transferring method in conventional switching hub is that the packet flow control mechanism is entirely controlled by the microprocessor. Therefore, the loading of the microprocessor is so heavy that the packet transfer efficiency is adversely affected. In addition, during accessing the packets in the memory according to the conventional packet transfer method, packets have to be moved within the memory, which results in the lowering of the process efficiency as a whole.

### SUMMARY OF THE INVENTION

It is therefore a primary objective of the present invention to provide a switching hub architecture and index-shared network packet transfer method thereof, which allows the microprocessor to rid of the responsibility of the packet flow control mechanism, in order to increase the overall transfer efficiency for the packets.

Another objective of the present invention is to provide a switching hub architecture and index-shared network packet transfer method thereof, which during the accessing of the packets in the memory, is free from moving packets in the memory so as to increase overall processing efficiency is increased.

The switching hub architecture and the index-shared network packet transfer method of the present invention can be suitably employed on a switching hub to more efficiently execute various packet transfer procedures than the prior art; the transfer procedures include a port-to-port packet transfer procedure, a port-to-microprocessor packet transfer procedure, and a microprocessor-to-port packet transfer procedure.

The switching hub architecture and the index-shared network packet transfer method of the present invention is characterized in that the packet-switching control unit within the switching hub and the microprocessor are both capable of retrieving an index from the same packet index buffer that indicates an unoccupied packet buffer area in the packet buffer memory, and the packet control mechanism can be executed by a packet transfer queue circuitry, thereby enhancing the packet transfer efficiency.

### BRIEF DESCRIPTION OF THE DRAWINGS

A better understanding of the substantial techniques and the embodiments of the present invention can be obtained when the forthcoming detailed description is considered in conjunction with the following drawings, in which:

Fig.1 is a system structural diagram, wherein the switching hub architecture of the present invention is shown;

FIG. 2A is a flowchart showing that steps of port-to-port packet transfer procedure are executed according to the switching hub architecture and the index-shared network packets transfer method thereof;

FIG. 2B is a flowchart showing that steps of port-to-microprocessor packet transfer procedures are executed according to the switching hub architecture and the index-shared network packets transfer method thereof; and

FIG. 2C is a flowchart showing that steps of microprocessor-to-port packet transfer procedures are executed according to the switching hub architecture and the index-shared network packets transfer method thereof.

### DETAILED DESCRIPTION OF THE PREFFERED EMBODIMENT

The detailed descriptions of specific embodiments implemented according to the switching hub architecture and the index-shared network packets transfer method of the present invention are illustrated below in conjunction with the accompanying drawings.

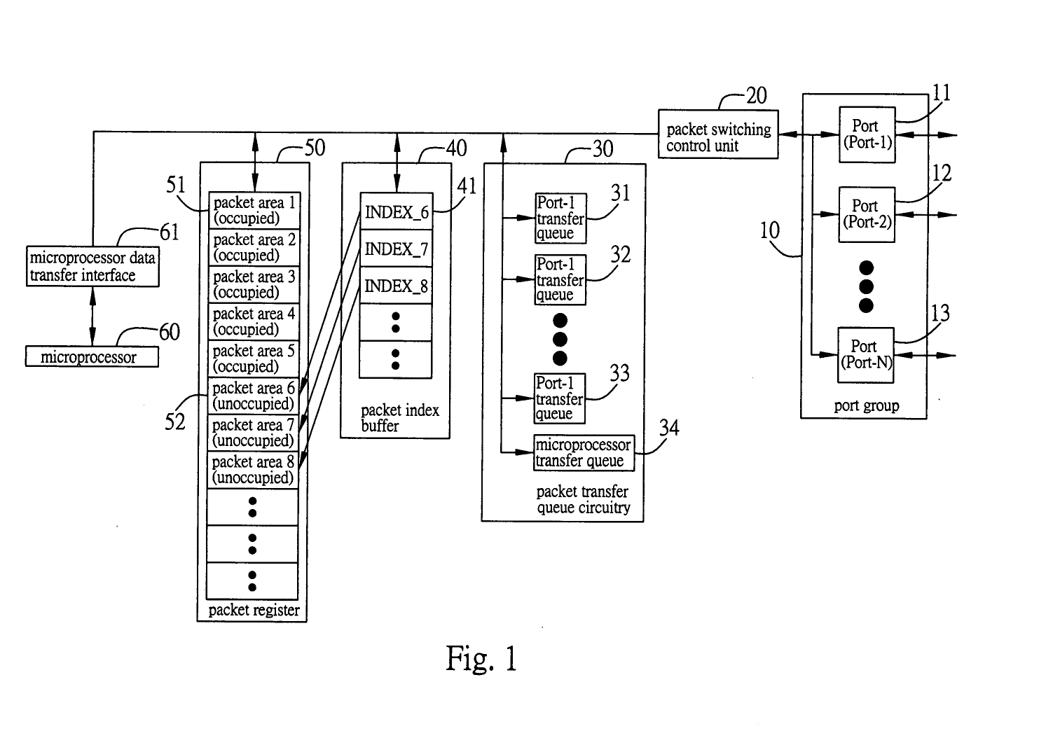

Fig.1 shows the switching hub architecture of the present invention. As shown in the diagram, the switching hub architecture is composed of: a port group 10, a packet switching control unit 20, a packet transfer queue circuitry 30, a packet index buffer 40, a packet register 50, and a microprocessor 60 and its data transfer interface 61.

The port group 10 includes a plurality of ports 11, 12, and 13, which can be connected externally to a plurality of network nodes (not shown), thereby allowing the network nodes to send packets between them through the switching hub.

The packet switching control unit 20 has a media access control (MAC) that controls the data transfer between the port group 10 and the packet register 50.

The packet transfer queue circuitry 30 is an independent temporary data storage unit comprising several port transfer queues 31, 32, and 33, and at least a microprocessor transfer queue 34; the port transfer queues 31, 32, and 33 respectively corresponds to each of the ports 11, 12, and 13, and the microprocessor transfer queue 34 corresponds to microprocessor 60.

The packet index buffer 40 is also an independent temporary data storage unit that temporarily stores the packet index 41 used to indicate an unoccupied packet area within the packet register 50, wherein each packet index 41 is used to index an unoccupied packet area within the buffer register 50.

The packet register 50 is used to store all the packets waiting to be processed, and the storage space therein is divided into a plurality of packet areas 51, each of the packet areas 51 is used to temporarily store a packet; and the addresses of those unoccupied packet areas 52 are recorded in the packet index 41 of the packet index buffer 40.

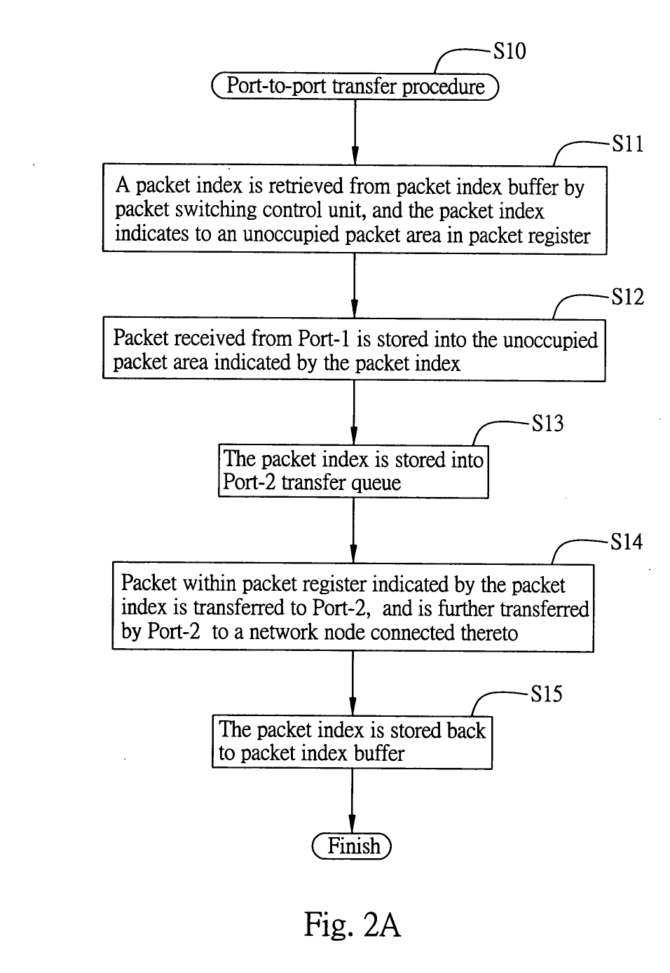

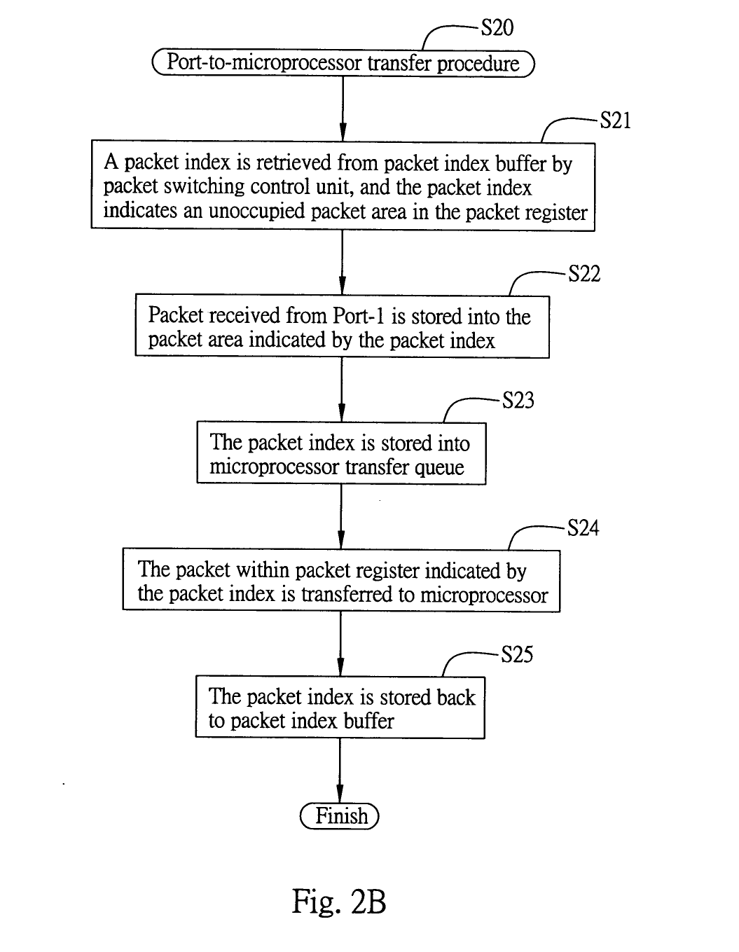

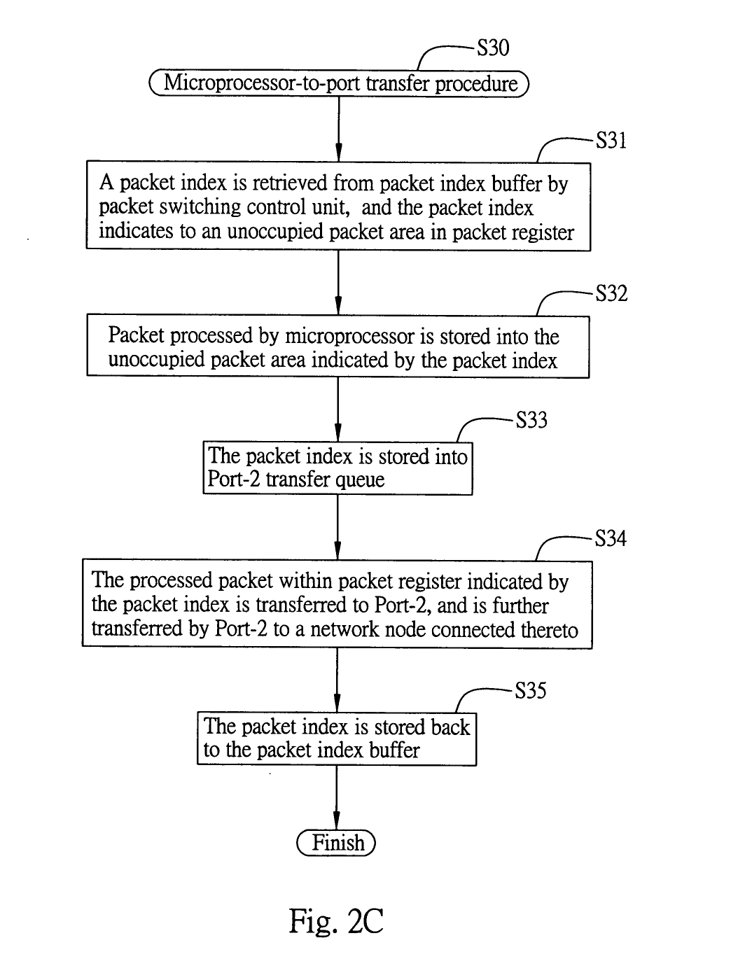

The various packet transfer procedures executed according to the switching hub architecture and the index-shared network packet transfer method of the present invention are illustrated respectively below and in conjunction with FIG. 2A to FIG. 2C, the packet transfer procedures includes: (1) port-to-port packet transfer procedure; (2) port-to-microprocessor packet transfer procedure; and (3) microprocessor-to-port packet transfer procedure.

Referring to both FIG. 2A and FIG. 1, in the example of the port-to-port packet transfer procedure, Port-1 11 in the switching hub is used to receive a packet and transfer this packet to Port-2 12.

First in step S11, a packet index is retrieved from the packet index buffer 40 by the packet switching control unit 20; wherein the packet index indicates an unoccupied packet area 52 in the packet register 50. The index retrieved is called as INDEX_{—}6.

Next in step S12, the packet received from Port-1 11 is stored into the unoccupied packet area indicated by the INDEX_{—}6 by the packet switching control unit 20.

Next in step S13, INDEX_{—}6 is stored into Port-2 transfer queue 32 by the packet switching control unit 20.

Then in step S14, the packet within the packet register 50 indicated by the INDEX_{—}6 in the Port-2 transfer queue 32 is accessed by the packet switching control unit 20, and this packet is then transferred to a determined destination, i.e., Port-2 12, to be thereby transferred by Port-2 12 to a network node (not shown) connected thereto.

Finally in step S15, INDEX_{—}6 is stored back to the packet index buffer 40 by the packet switching control unit 20, thereby completing a port-to-port transfer procedure.

Now referring to FIG. 2B and FIG. 1, in the example of the port-to-microprocessor packet transfer procedure, Port-1 11 in the switching hub is used to receive a packet and to transfer this packet to the microprocessor 60 for processing.

First in step S21, a packet index is retrieved from the packet index buffer 40 by the packet switching control unit 20; wherein the packet index indicates to an unoccupied packet area in the packet register 50. The packet index retrieved is called as INDEX_{—}7.

Next in step S22, the packet received from Port-1 11 is stored into the unoccupied packet area indicated to by the INDEX_{—}7 by the packet switching control unit 20.

Next in step S23, INDEX_{—}7 is stored into microprocessor transfer queue 34 by the packet switching control unit 20.

Then in step S24, the packet within the packet register 50 indicated by the INDEX_{—}7 in the microprocessor transfer queue 34 is accessed by the packet switching control unit 20, and this packet is then transferred to the microprocessor 60 via the data transfer interface 61, so that the microprocessor 60 can execute processing tasks on the packet.

Finally in step S25, INDEX_{—}7 is stored back to the packet index buffer 40 by the packet switching control unit 20, thereby completing a port-to-microprocessor transfer procedure.

Now referring to FIG. 2C and FIG. 1, in the example of the microprocessor-to-port packet transfer procedure, the microprocessor 60 is used to transfer the processed packet to Port-2 12.

First in step S31, a packet index is retrieved from the packet index buffer 40 by the microprocessor 60 via the data transfer interface 61; wherein the index indicates to an unoccupied packet area in the packet register 50. The packet index retrieved is called as INDEX_{—}8

Next in step S32, the packet processed by the microprocessor 60 is stored into the packet area indicated by the INDEX_{—}8 via the data transfer interface 61.

Next in step S33, INDEX_{—}8 is stored into Port-2 transfer queue 32 by the microprocessor 60 via the data transfer interface 61.

Then in step S34, the processed packet within the packet register 50 indicated by the INDEX_{—}8 in Port-2 transfer queue 32 is accessed by the microprocessor 60 via the data transfer interface 61, and this processed packet is then transferred to a corresponding destination, i.e. Port-2 12, and further transferred by Port-2 12 to a network node (not shown) connected thereto.

Finally in step S35, INDEX_{—}8 is stored back to the packet index buffer 40 by the microprocessor 60, thereby completing a microprocessor-to-port transfer procedure.

In summary, the present invention provides a new switching hub architecture and the index-shared network packet transfer method, which may be suitably employed on a switching hub to carry out various packet transfer procedures in a more efficient manner. Since the proposed switching hub architecture and index-shared packet transfer method thereof is characterized in that the embedded packet-switching control unit and microprocessor are both capable of retrieving a packet index from the same packet index buffer that indicates an unoccupied packet buffer area in the packet buffer memory, the packet flow control mechanism can be executed by the packet transfer queue circuitry such that packet transfer efficiency can be improved.

The above descriptions are only illustrative of the preferred embodiments of the present invention, and are not intended to limit the scope of the essential technique of the present invention. The scope of the invention is broadly defined by the claims appended hereto. If any physical forms or methods implemented by the others are identical or equivalent to those defined in the claims below, they are considered to be within the scope of the claims.

1. A switching hub architecture comprising:
a plurality of ports for transferring packets;
a packet switching control unit for controlling a packet transfer procedure of each of the ports;
a microprocessor for processing packets received from each of the ports;
a packet transfer queue circuitry for temporarily storing the packet transfer queues between the microprocessor and the ports;
a packet register divided into a plurality of packet areas and being used for temporarily storing packets of each of the ports transferred during the packet transfer procedure; and
a packet index buffer for temporarily storing index data, wherein each of the indexes is used to indicate an unoccupied packet area in the packet register;
wherein
during the packet transfer procedure, at least one of the packet switching control unit and the microprocessor is capable of accessing any one of the packet indexes stored in the packet index buffer, so as to transfer packets from the ports to be temporarily stored in the unoccupied packet area in the packet register indicated by the packet index accessed by the packet switching control unit or the microprocessor.

2. The switching hub architecture as claimed in claim 1, wherein the packet transfer procedure comprises a port-to-port packet transfer procedure, a port-to-microprocessor packet transfer procedure, and a microprocessor-to-port packet transfer procedure.

3. An index-shared network packet transfer method, suitable for use in a switching hub consisting of a plurality of ports, a packet switching control unit, a packet index buffer, a packet transfer queue, a packet register, and a microprocessor and a data transfer interface thereof, allowing the packet transfer procedure to be carried out between the plurality of ports and the microprocessor; the method comprising the steps of:
(1) if a first port of the switching hub receives a packet, and the packet is to be transferred to a second port, then executing a port-to-port packet transfer procedure that comprises the following procedure steps:
(1-1) retrieving from the packet index buffer by the packet switching control unit a packet index which indicates an unoccupied packet area in the packet register;
(1-2) storing the packet received from the first port in the unoccupied packet area indicated by the packet index retrieved by the packet switching control unit;
(1-3) storing the packet index in a transfer queue of the second port by the packet switching control unit;
(1-4) transferring to the second port the packet within the packet register indicated by the packet index by the packet switching control unit, so as for the packet to be further transferred by the second port to a network node connected thereto;
(1-5) storing back the packet index to the packet index buffer by the packet switching control unit;
(2) if a port of the switching hub receives a packet, and the packet is to be transferred to the microprocessor, then executing a port-to-microprocessor packet transfer procedure that comprises the following procedure steps:
(2-1) retrieving a packet index from the packet index buffer by the packet switching control unit, wherein the index indicates an unoccupied packet area in the packet register;
(2-2) storing the packet received from the port in the unoccupied packet area indicated by the packet index retrieved by the packet switching control unit;
(2-3) storing the packet index in a transfer queue of the microprocessor by the packet switching control unit;
(2-4) transferring the packet within the packet register indicated by the packet index to the microprocessor by the packet switching control unit;
(2-5) storing back the packet index to the packet index buffer by the packet switching control unit;
(3) if the microprocessor is to transfer the processed packet to a port, then executing a microprocessor-to-port packet transfer procedure that comprises the following procedure steps:
(3-1) retrieving a packet index from the packet index buffer by the microprocessor, wherein the packet index indicates an unoccupied packet area in the packet register;
(3-2) storing the processed packet by the microprocessor in the unoccupied packet area indicated by the packet index;
(3-3) storing the packet index in a transfer queue of the port by the microprocessor;
(3-4) transferring the processed packet within the packet register indicated to the port by the microprocessor so as for the processed packet to be transferred by the port to a network node connected thereto; and
(3-5) storing back the packet index i to the packet index buffer by the microprocessor.
